(19) United States
(12) Patent Application Publication
(10) Pub. No.: US 2014/0158773 A1
(43) Pub. Date: Jun. 12, 2014

(54) TRANSACTION CARDS AND ASSOCIATED METHODS

(71) Applicant: BLACK CARD LLC, Jackson, WY (US)

(72) Inventor: Scott Alan Blum, Jackson, WY (US)

(73) Assignee: Black Card LLC, Jackson, WY (US)

(21) Appl. No.: 13/830,636

(22) Filed: Mar. 14, 2013

Related U.S. Application Data
(60) Provisional application No. 61/734,279, filed on Dec. 6, 2012.

(51) Int. Cl. G06K 19/02

(52) U.S. Cl. CPC G06K 19/02
USPC 235/487; 156/220

(57) ABSTRACT

A transaction card having a first layer and a second layer, wherein the first layer is metal and the second layer is a polymer.

### CROSS-REFERENCE TO RELATED APPLICATIONS

This application claims priority to provisional application Ser. No. 61/734,279, filed on Dec. 6, 2012, the entire contents of which are hereby incorporated by reference.

### BACKGROUND

The present embodiments relate to transaction cards, such as credit cards and debit cards, that are used as substitutes for cash.

### DESCRIPTION OF RELATED ART

The vast majority of transaction cards in use today are constructed of plastic. These cards tend to be flimsy and wear out or break easily.

### SUMMARY

The preferred embodiments of the present transaction card have several features, no single one of which is solely responsible for their desirable attributes. Without limiting the scope of the present embodiments as expressed by the claims that follow, their more prominent features will now be discussed briefly. After considering this discussion, and particularly after reading the section entitled “Detailed Description of the Preferred Embodiments,” one will understand how the features of the present embodiments provide advantages, which include increased strength and durability, greater rigidity, decreased weight, longer lifespan, enhanced feel and high tech look.

One embodiment of the present transaction card comprises a substantially planar sheet having a front surface, a back surface and a continuous peripheral edge. The planar sheet includes a first layer and a second layer. The first layer is metal and the second layer is a polymer.

### BRIEF DESCRIPTION OF THE DRAWINGS

The preferred embodiments of the present transaction card will now be discussed in detail with an emphasis on highlighting the advantageous features. These embodiments depict the novel and non-obvious transaction card shown in the accompanying drawings, which are for illustrative purposes only. These drawings include the following figures, in which like numerals indicate like parts:

FIG. 1 is a front elevation view of one embodiment of the present transaction card;

FIG. 2 is a rear elevation view of the transaction card of FIG. 1;

FIG. 3 is a side elevation view of the transaction card of FIG. 1; and

FIG. 4 is a flowchart illustrating a process for making transaction cards, according to the present embodiments.

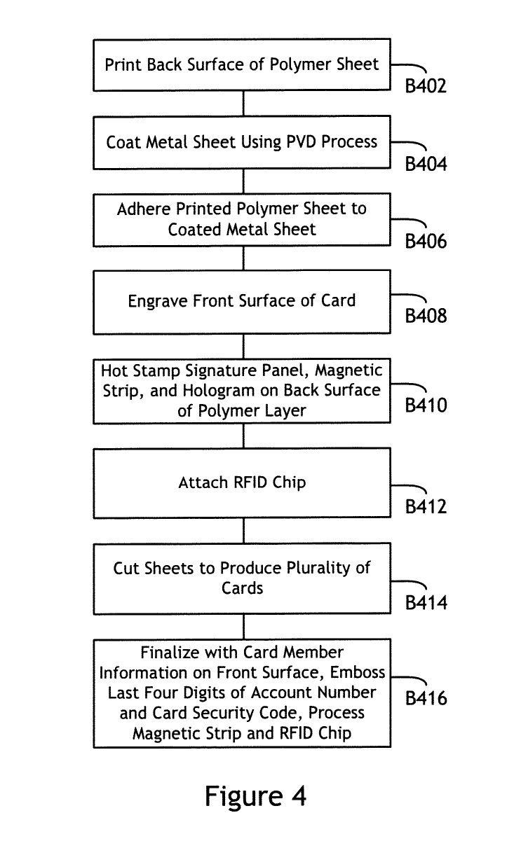

### DETAILED DESCRIPTION OF THE PREFERRED EMBODIMENTS

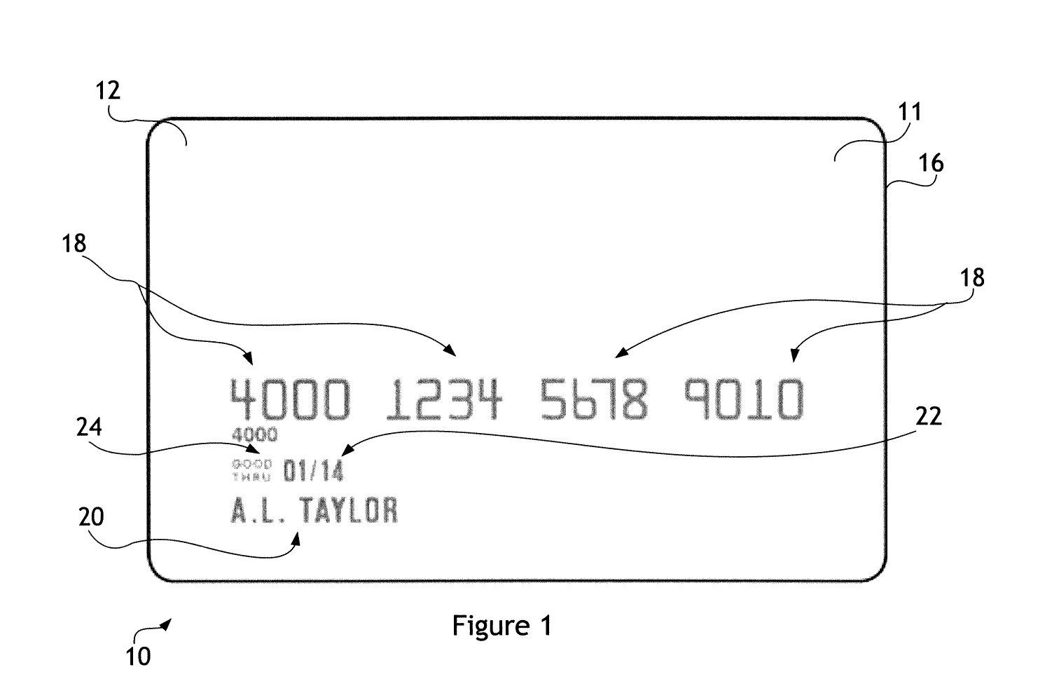

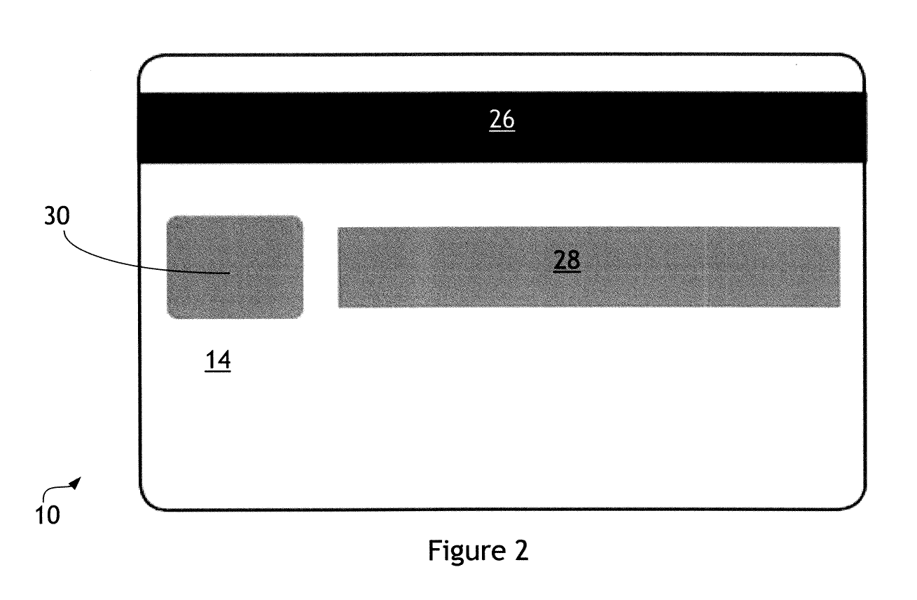

With reference to FIGS. 1 and 2, the present transaction card 10 is a substantially planar sheet 11 having a front surface 12 and a back surface 14. The card 10 includes a continuous peripheral edge 16, which in the illustrated embodiment is substantially rectangular. However, those of ordinary skill in the art will appreciate that the card 10 could have virtually any shape, such as square, round or hexagonal. The scope of the present card 10 is not limited to any particular shape.

In the illustrated embodiment, the transaction card 10 bears a number 18 (FIG. 1) that identifies the card 10 as being associated with a particular account. In the illustrated embodiment, the account number 18 has sixteen digits. However, in alternative embodiments the card 10 may have fewer or more digits. The card 10 also bears the name 20 of the cardholder and an expiration date 22. In certain embodiments, the card 10 may also bear a year 24 or date on which the cardholder first acquired the card 10. The information displayed on the card 10 may be applied in any suitable manner, such as embossing, printing, engraving, etching, etc.

With reference to FIG. 2, the back surface 14 of the present transaction card 10 includes a magnetic strip 26. The magnetic strip 26 stores information that is readable by a magnetic reader. For example, the magnetic strip 26 may contain a series of digits from which the magnetic card reader can obtain information about the account associated with the card 10 and/or the cardholder. The back surface 14 of the present transaction card 10 further includes a signature panel 28.

The present transaction card 10 further includes an embedded chip 30, such as a radio-frequency identification (RFID) chip or an EMV (Europay, MasterCard and VISA) chip 30. RFID is a wireless non-contact system that uses radio-frequency electromagnetic fields to transfer data from the chip 30 to a receiver for the purposes of automatic identification and tracking. EMV is a global standard for inter-operation of integrated circuit cards (IC cards or “chip cards”) and IC card capable point of sale (POS) terminals and automated teller machines (ATMs), for authenticating credit and debit card transactions. While not shown, the card 10 may further include a holographic image 32, which is useful to discourage counterfeiting. While also not shown, the card 10 may further include one or more transparent portions. Such transparent portions may include one or more optically recognizable layers or infrared-blocking ink to allow the transparent portion(s) to be recognized by an optical card reader. These additional features may allow the transaction card 10 to function more easily, efficiently, and/or more securely.

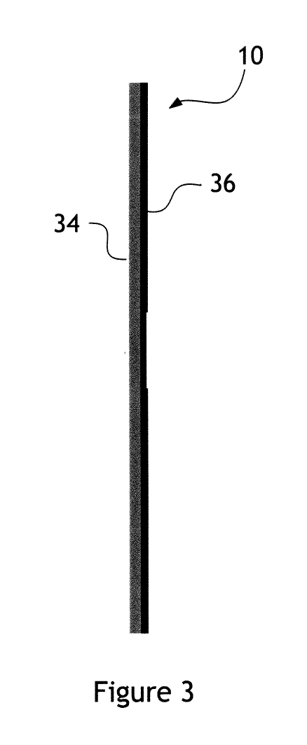

With reference to FIG. 3, the planar sheet 11 is constructed of a front layer 34 and a back layer 36. In the illustrated embodiment, the front layer 34 is a metal and the back layer 36 is a polymer. A non-exhaustive and non-limiting list of example metals and metal alloys for the front layer 34 includes scandium, titanium, vanadium, chromium, manganese, iron. cobalt, nickel, copper, zinc, yttrium, zirconium, niobium, molybdenum, technetium, ruthenium. rhodium, palladium, silver, cadmium, hafnium, tantalum, tungsten, rhenium, osmium, iridium, platinum, gold, aluminum, gallium, indium, thallium, lead, bismuth, tin, stainless steel, bronze, brass, nickel-silver, and any combination(s) of the foregoing. A non-exhaustive and non-limiting list of example polymers for the back layer 36 includes polyethylene, polyethylene terephthalate, polypropylene, polystyrene, polytetrafluoroethylene, polyvinylchloride (PVC), polychlorotrifluoroethylene, polyacrylonitrile, polychloroprene, polyurethane, polyamide (nylon), and polyacrylamide. The front and back layers 34, 36 may, for example, be adhered to one another with an adhesive or secured in any other manner.

In the illustrated embodiment, the front layer 34 may be about 0.02″ thick, and the back layer 36 may be about 0.013″ thick, for an overall thickness of 0.033″ for the card 10. In another embodiment, the front layer 34 may be about 0.02″ thick, and the back layer 36 may be about 0.007″ thick, for an overall thickness of 0.027″ for the card 10. In still other embodiments, the overall card thickness may be in the range of 0.0315″-0.032″. However, the foregoing dimensions are not limiting, as the card 10 and/or its layers 34, 36 could have any thickness.

In some embodiments the front layer 34 may include a coating, such as a physical vapor deposition (PVD) coating. The PVD coating may be, for example, black in color. In certain other embodiments the card 10 may include additional layers, with at least one of the layers being one or more polymeric materials. For example, outer layers of the card 10 may be polymeric while inner layers of the card 10 are carbon, or metal, or vice versa.

The vast majority of today's transaction cards are constructed of plastic. The present transaction card 10 is advantageously stronger and more durable than such plastic cards. It is also more rigid, lighter, and has a longer lifespan. In addition to these benefits, the metal/polymer combination provides the card 10 with a unique feel and high tech look. The card 10 is thus more desirable for its distinctiveness over a typical plastic card.

A process of making the present card 10 may comprise printing a back surface of a planar polymer sheet with text, as shown at block B402. The text may include the text shown in FIG. 2, and/or an Internet address with information relating to the card 10, and/or one or more customer service phone numbers, and/or other text. The printing may be carried out on a sheet of the polymer layer 36 that will eventually be cut in a grid pattern to separate a plurality of cards 10 from one another.

The process further comprises coating a sheet of metal with a black coating using a PVD process, as shown at block B404. Again, the coating may be carried out on a sheet of the metal layer 34 that will eventually be cut in a grid pattern to separate a plurality of cards 10 from one another. In alternative embodiments, the coating process may be a process other than PVD, such as diamond-like carbon (DLC) application process. Further, in alternative embodiments the coating may be a color other than black.

The process further comprises adhering the printed polymer sheet to the coated metal sheet, as shown at block B406. The front surface 12 of the card 10 may then be etched to create additional text and/or an ornamental design, as shown at block B408. In alternative embodiments, the additional text and/or an ornamental design may be applied with a process other than etching, such as engraving.

The process further comprises hot stamping the signature panel, magnetic strip, and hologram onto the back surface of the card 10, and attaching the RFID chip, as shown at blocks B410 and B412, respectively. The sheets are then cut to produce a plurality of cards 10, as shown at block B414. In one embodiment, the metal and polymer sheets may measure 19.875″×25.20″, and when cut each card 10 measures 3.370″×2.125″. Each card 10 is then finalized with the card member information on the front surface 10, embossed with the last four digits of the account number and the card security code on the signature panel, and the magnetic strip and RFID chip are processed, as shown at block B416.

The above description presents the best mode contemplated for carrying out the present transaction card, and of the manner and process of making and using it, in such full, clear, concise, and exact terms as to enable any person skilled in the art to which it pertains to make and use this transaction card. This transaction card is. however, susceptible to modifications and alternate constructions from that discussed above that are fully equivalent. Consequently, this transaction card is not limited to the particular embodiments disclosed. On the contrary, this transaction card covers all modifications and alternate constructions coming within the spirit and scope of the transaction card as generally expressed by the following claims, which particularly point out and distinctly claim the subject matter of the transaction card.

What is claimed is:

1. A transaction card, comprising:
a substantially planar sheet having a front surface, a back surface and a continuous peripheral edge;
wherein the planar sheet includes a first layer and a second layer.

2. The transaction card of claim 1, wherein the first layer is metal and the second layer is a polymer.

3. The transaction card of claim 2, wherein the metal layer comprises scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, aluminum, gallium, indium, thallium, lead, bismuth, tin, stainless steel, bronze, brass, or nickel-silver.

4. The transaction card of claim 2, wherein the polymer layer comprises polyethylene, polyethylene terephthalate, polypropylene, polystyrene, polytetrafluoroethylene, polyvinylchloride (PVC), polychlorotrifluoroethylene, polyacrylonitrile, polychloroprene, polyurethane, polyamide (nylon), or polyacrylamide.

5. A process of making a transaction card, the method comprising:
printing a back surface of a planar polymer sheet with text;
coating a metal sheet of with a black coating;
adhering the printed polymer sheet to the coated metal sheet; and
hot stamping a signature panel, a magnetic strip, and a hologram onto a back surface of the card.

6. The method of claim 5, further comprising applying a design to a front surface of the card.

7. The method of claim 6, wherein the design comprises interlocking recitations of “BLACK CARD.”

8. The method of claim 6, wherein applying the design comprises etching.

9. The method of claim 6, wherein applying the design comprises engraving.

10. The method of claim 5, further comprising attaching a radio frequency identification (RFID) chip to the card.
